(19) United States
(12) Patent Application Publication
(10) Pub. No.: US 2017/0163485 A1
(43) Pub. Date: Jun. 8, 2017

(54) FULL CONFIGURATION MANAGEMENT OF MULTI-DOMAIN MULTI-VENDOR NETWORK EQUIPMENTS USING GOLDEN CONFIGURATIONS AND SNAPSHOTS

(71) Applicants: ALCATEL - LUCENT INDIA, LTD., Bangalore (IN); ALCATEL-LUCENT CANADA INC., Ottawa (CA)

(72) Inventors: Mohammad Reza Rokui, Ottawa (CA); Prabhu TS, Bangalore (IN); Sundaram Chidambaram, Kanata (CA)

(73) Assignees: ALCATEL-LUCENT CANADA INC.; ALCATEL - LUCENT INDIA, LTD.

(21) Appl. No.: 14/960,947

(22) Filed: Dec. 7, 2015

(51) Int. Cl. H04L 12/24

(52) U.S. Cl. CPC H04L 41/0823

(57) ABSTRACT

Various exemplary embodiments relate to a network device configured to perform a method of configuration, the device including a memory; and a processor configured to: build an object model; create an XML-equivalent using the network element configuration file as input; create a dependency model; and perform deployment logic based on creation of the dependency model.

### TECHNICAL FIELD

Various exemplary embodiments disclosed herein relate generally to computer networking.

### BACKGROUND

The Telecommunications networks are evolving increasingly to be more flexible and powerful. The Internet Protocol (IP)/Multiprotocol Label Switching (MPLS), Optical transport and Wireless networks support a multitude of network services that are evolving quickly. As a result, the content of node configuration is becoming more complex and more dynamic which means that addressing aspects of network configuration integrity is fundamental to effective management of today's network devices.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of configuration of a multi-domain multi-vendor network device, the method including building an object model; creating a network element configuration file using the object model as input; creating a dependency model; and performing deployment logic based on creation of the dependency model.

Various exemplary embodiments relate to a network device configured to perform a method of configuration, the device including a memory; and a processor configured to: build an object model; create a network element configuration file using the object model as input; create a dependency model; and perform deployment logic based on creation of the dependency model.

### BRIEF DESCRIPTION OF THE DRAWINGS

In order to better understand various exemplary embodiments, reference is made to the accompanying drawings, wherein:

FIG. 1 illustrates an exemplary configuration management of multi-vendor multi-domain network equipments;

FIG. 2 illustrates an exemplary method for creation of an object model;

FIG. 3 illustrates an exemplary interface object model;

FIG. 4 illustrates an exemplary method for creation of a dependency model;

FIG. 5 illustrates exemplary embodiment of a dependency model; and

FIG. 6 illustrates an exemplary method for deployment logic.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Aspects of network configuration which are fundamental to effective management of today's network devices include:
Providing mechanisms to create a backup of network element configuration at any point in time. Also, a mechanism to retain certain number of created backups at various points in time.
Easy and robust solutions to display the configuration of the network devices: The network operators desire an easy way to display the current configuration of nodes and also the previous saved configurations.
A mechanism to audit and compare the current node configurations against snapshots or golden configurations (GC) which were created in the past.
Robust and rapid configuration and deployment to network equipment, it is important to make sure the configuration of network devices is correct. In case the node configuration is not correct or needs to be modified (as a result of adding new services or modifying the current services), there should be a simple and robust mechanism to deploy the changes in bulk to multiple nodes at once.
A robust and easy method to deploy the result of audit or comparison to the network equipment: During the auditing the configuration of multiple network equipments against a well-known snapshot or golden-configuration, there should be a way to deploy the changes to network equipments in bulk. This may ensure the consistency of the configuration on all network elements.

Embodiments address complete configuration management capabilities including backup/restore of configuration, creation and display of Golden Configuration and Snapshots, audit and comparison of node configuration against golden configuration or Snapshots and full or partial deployment to simplify the workflow for the network operator. By using different embodiments, network operators can take snapshots of a configuration of all nodes in the network at a given instant of time. Snapshots taken can be used for audits and they can be converted to golden configuration which can be used for deployment on other nodes. Audit operations will help the operator to find the configuration difference which might have resulted in service disruption. In addition, the whole process can be scheduled in order to automate backup/restore, audit, creation and deployment of the golden configuration.

Embodiments will also address the multi-vendor and multi-domain aspects of the network as well. Namely, for a network using equipment from more than one vendor it is critical to achieve a complete configuration management for all network equipment from all vendors. Embodiments of the Golden Configuration application may be multi-vendor which means that the process of creation, audit and deployment of golden configuration can be done on network equipment from different vendors at once with the same workflow. Embodiments are also multi-domain which means that the equipment from different domains such as IP/MPLS, Optics and Wireless may be treated the same in terms of configuration management.

Some embodiments include complete and comprehensive configuration management capabilities in multi-domain multi-vendor networks in the following areas:
The creation of backup configuration for future restore.
The creation and display of Golden Configuration and Snapshots.
The audit and comparison of node configurations against Golden Configuration and Snapshots.
The full or partial deployment of Golden Configuration and Snapshots to multiple network elements in bulk.
Different domains such as IP/MPLS, Optics, and Wireless (both RAN and EPC) through a unified interface.
Providing a method to create Golden Configuration from Snapshots.
Addressing all configuration areas of network elements including Equipments, QoS Policies,
Routing, Profiles, MPLS, Tunnels, Services, Security and so on all at once.
Addressing the multi-vendor aspect of the today's network elements.
Addressing both proactive and passive configuration management, such as on-demand: All aspects of configuration management may be invoked on-demand or may be scheduled by operator for future actions.

Some differences between Golden Configuration and Snapshot include:

Embodiments of Golden Configuration (GC) include a few well-defined configurations such as Gold, Silver and Bronze that may be deployed to multiple network elements. One important aspect of these golden configurations is that these configurations may not contain any node personalities such as system IP address, network TIP addresses, port Medium Access Control (MAC) addresses, node name, port name and so on. When deployed to multiple network elements, the golden configurations must be exactly die same on all network elements. The golden configurations may contain equipments. Quality of Service (QoS) Polices, Routing Policies, Tunnel definitions, Security and so on.

Embodiments of Snapshot include configuration of a single network element over time. As a result, the Snapshots are identified by two parameters; one is the network element identification such as IP Address or MAC address of a single network element and the other one is time. The Snapshot of one network element may not be deployed or audited against the Snapshot of another network element. In addition to content of GC, the Snapshots might contain Interfaces, Services. Routing, MPLS and so on.

Embodiments provide a unified interface to create both GC and Snapshot from any network equipment in the network either on-demand or using the scheduled capability. Embodiments allow creating the GC from Snapshot by removing all the personalities from the Snapshot such as IP Addresses, MAC addresses, string names etc. The operator may also specify a filter to include or exclude any configuration from both GC and Snapshot during creation. Embodiments also provide an interface to display the content of any Golden Configurations or Snapshots after creation.

Embodiments include an audit or comparison operation. Many operational problem facing today's network result from mis-configuration by network operators. A web application may also provide the capability of the audit and comparison between the following:
The current configuration of any network element with one of its Snapshots taken in the past.
For any network element, the comparison between any two Snapshots taken in the past.
The comparison of any network element with one of the Golden Configurations.

Embodiments include a Golden Configuration Web Application which uses an Extreme Markup Language (XML) equivalent of network equipment configuration for audit and deployment capabilities. The content of the XML file may include a data model, which could be in any format such as YANG used with NETCONF as communication channel or Structure of Management Information (SMI) used in SNMP or any other data modeling. The logic proposed in the patent shall be very generic and versatile to work with any type of data models. The data model explains how the constructs for all the component of the configuration file should be built. For those network equipments which are command line interface-based (CLI) and do not support XML, a sophisticated logic (called CLI2XML) is invented to change the CIA configuration to a XML equivalent using the data model which then may be used in all embodiments in this patent application. The CLI2XML logic may take the CLI configuration of the network element along with a set of metadata and data model and generate the XML equivalent of the network element configuration which then may be used. The important aspect of this XML equivalent is that it creates an abstraction of the network equipment configuration. Using this sophisticated logic, any network element which does not support the XML model of the configuration may be potentially integrated for audit and deployment.

Some important tools for network operators, may include embodiments which address the multi-domain aspect of the today's communication networks. Embodiments may cover a wide variety of network equipments in areas of IP, MPLS, Optics and Wireless. When these network elements support NETCONF/YANG model, their configuration could be imported natively. Otherwise, the CLI2XML tool may be used to transform the configuration of the network element to XML equivalent which in turn may be imported to the application for further backup, restore, audit and deployment.

Other embodiments include both Golden Configurations and Snapshots which may be used for audit and deployment operations together. The audit process is completely customizable by operator to include or exclude any part of configuration and will identify any changes between network equipment and Golden Configuration or Snapshots. The deployment process may be combined with or without audit. In other words, the operator may deploy the entire Golden Configuration or Snapshot to the network equipment or may deploy the result of the audit process. In case there are differences between the configuration of network equipment and Golden Configurations or Snapshots, the full or partial deployment of the differences to the network element is allowed.

In some embodiments the “contextual” comparison and deployment to make the backup, audit and deployment of large configuration date scalable and fast is added. The main idea behind network configuration diagnostic is to compare two different backups, Snapshots or Golden Configurations and to identify the configurations that could be causing unwanted behavior. One of the key areas of the embodiments is to make “contextual” comparison to narrow down large amount of configuration data and quickly highlight differences between any two given backups. This is done using XSLT (Extensible Stylesheet Language Transformations) and XML schemas.

Some embodiments apply the Golden Configurations to a snapshot or inputs from the operator and deploy the result to a large group of network elements in bulk. The first step of this process is to take a user input Golden Configuration data file and apply that on top of a user picked backup data, resulting in a unique configuration file that may be applied to a given network element.

Some embodiments also pertain to diagnosing of a Large deployment of network elements. As part of diagnosing functionality mechanisms, it is possible to create backup of network element configuration at any point in time. Also, there will be mechanisms to retain certain number of created backups at various points in time. Operators may also have options to create scheduled backups.

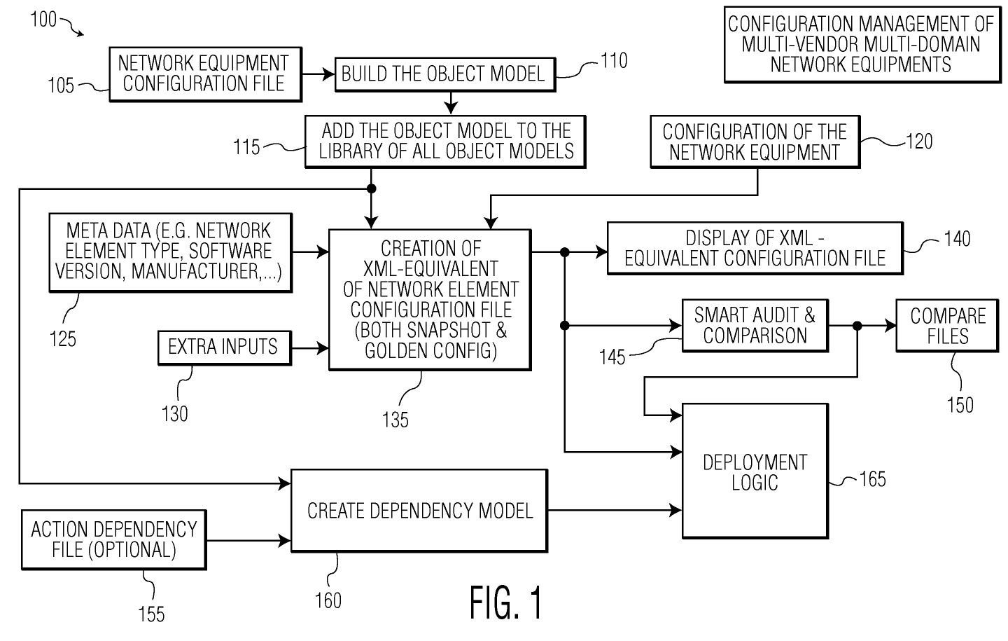

FIG. 1 illustrates an exemplary configuration management system of multi-vendor multi-domain network equipment 100. Configuration management system 100 shows building blocks of a full configuration management system for a multi-vendor and multi-domain network equipment.

The first steps include the creation of the Object Model Library. These are the object models of content of the network equipment configuration file. These object models can be built for multiple network elements and can be kept in a library for further use by other blocks.

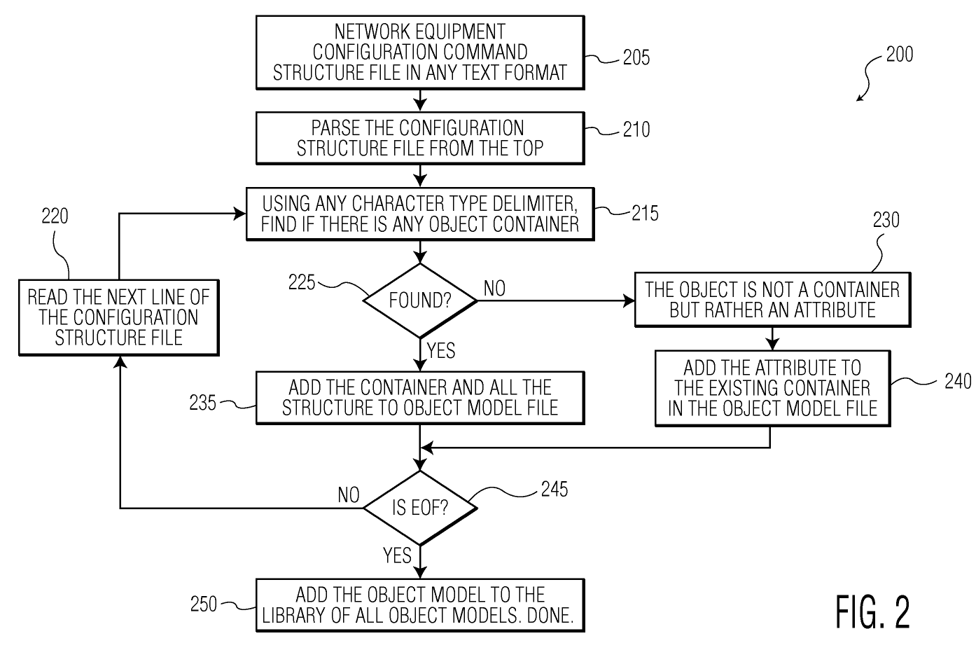

In step 105 the configuration management system may submit or create a network equipment configuration file. The configuration management system may them move to step 110 where the configuration management system may build the object model. In step 160, configuration management system may perform the steps performed in FIG. 2. The configuration management system may then move to step 115 where it may add the object model to the library of all object models.

The next step is to create an abstract content of the configuration file called XML-Equivalent. The object model from the library and the configuration file of the network element may be used to generate this XML-equivalent.

The configuration management system may then move to step 135 where it may create an XML equivalent of the network element configuration file, for example using both the Snapshot and the Golden Configuration. It uses input from steps 120, 125 and 130.

The configuration management system may use configuration of the network equipment in step 120 as input to the XML equivalents file in step 135. The configuration management system may provide meta data such as network elements type, software versions and manufacturer information in step 125 as input to creation of XML equivalent network configuration file in step 135. Similarly, in step 130, the configuration management system may provide extra inputs (such as an include or exclude lists) to the creation of XML equivalents of the network element configuration file in step 135.

From step 135, the configuration management system may proceed to steps 140, 145 or 165 depends on the action needed. In proceeding to step 140, configuration management system may then display the XML equivalent configuration file. In step 145, configuration management system may perform a smart audit and comparison. From step 145, configuration management system may move to step 150 where it generates the compare files. Similarly, from step 145, configuration management system may move to step 165 where it may perform the deployment logic.

The configuration management system may then move to step 155, 160 and 165 to address the Deployment, which is modifying the configuration on the network equipment either partially or fully. An abstract model created in step 135 may be used for Deployment. To this end, we need a new concept called the dependency model, which may contain the pre-deployment and post-deployment objects and actions. In general the partial deployment to the network equipment is a complex process. Prior to partial deployment of configuration to a network element, some pre-deployment actions should be taken. Also after the deployment, some post-deployment actions (which is reverse of pre-deployment actions) should be taken. The Dependency Model contains the important information related to the pre-deployment and post-deployment actions and objects and will be used during the deployment. The creation of the dependency model will be discussed in next section.

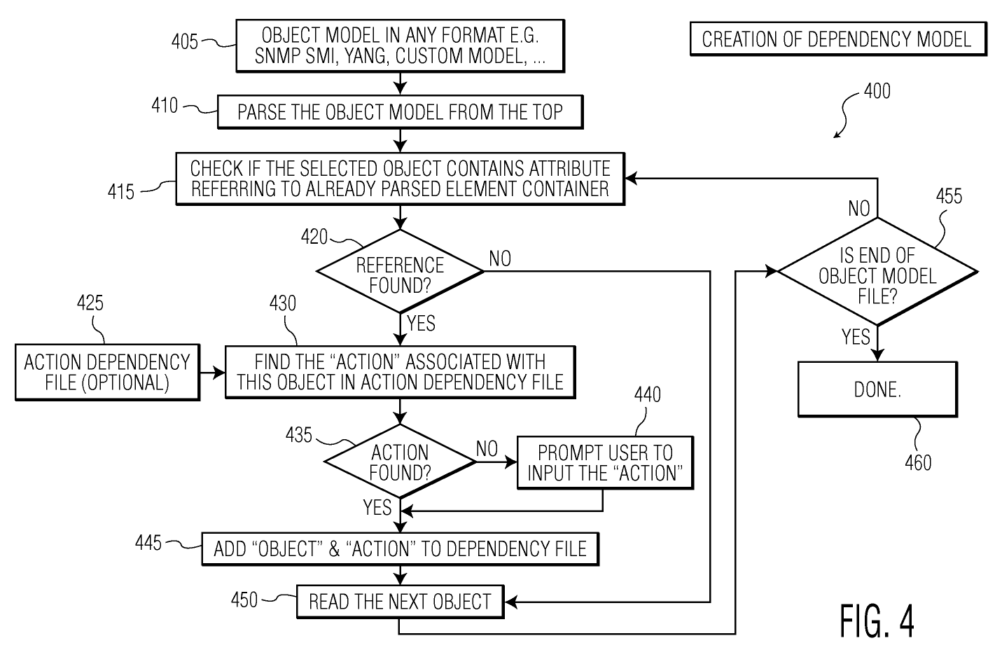

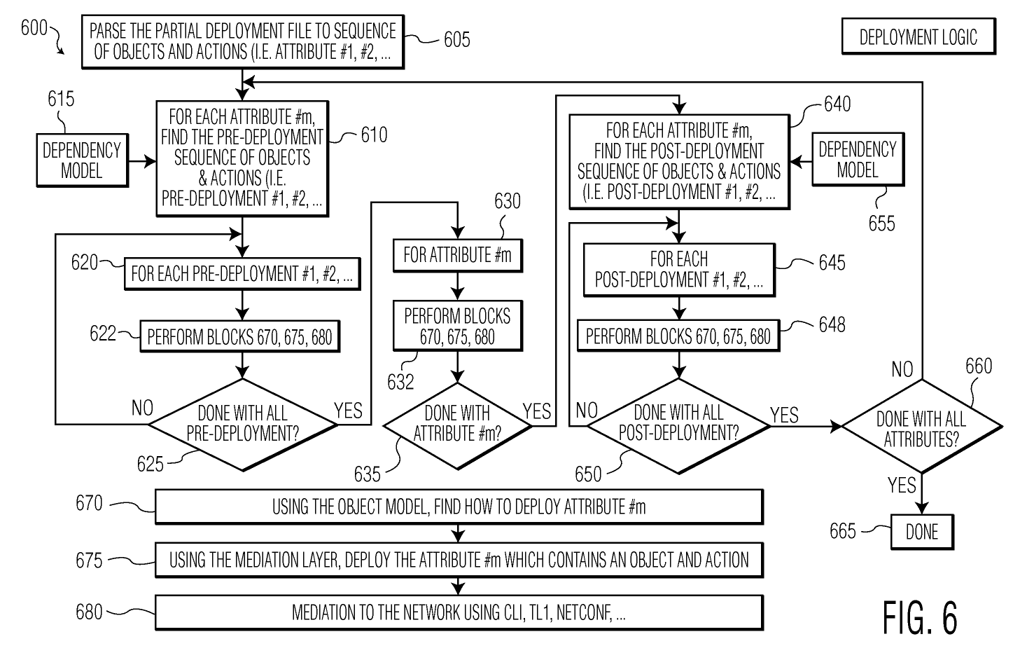

To create the dependency model steps 155 and 160 may be used. The configuration management system may move directly to step 165 from step 135, or step 160, where it may perform the deployment logic. In step 160, the dependency model will be created using the Object model from step 115 and an optional action dependency file from step 155. In step 160, configuration management system may perform the steps performed in FIG. 4. Also in step 165, configuration management system may perform the steps performed in FIG. 6.

FIG. 2 illustrates an exemplary method for creation of an object model 200. In step 205, the configuration management system may create and present a network equipment configuration command structure file in any text format.

Configuration management system may then proceed to step 210 where it may parse the configuration structure file from the top of the file.

Configuration management system may then proceed to step 215 where it may find if there is any object container, using any character type delimiter.

Configuration management system may then proceed to step 225 where it may determine if an object container is found. When an object container is found the configuration management system may proceed to step 235 where it may add the container and all the structure to the object model file. From step 235, configuration management system may proceed to step 245 where it may determine if the end of file has been reached.

When an object container is not found, the configuration management system may proceed to step 230 where it may determine that the object is not a container but rather an attribute. From step 230, the configuration management system may proceed to step 240 where it may add the attribute to the existing container in the object model file. From step 240, configuration management system may proceed to step 245 where it may determine if the end of file has been reached.

When the configuration management system determines that the end of file has been reached in step 245, the configuration management system may proceed to step 250 where it may add the object model to the library of all object models and then cease. When the configuration management system determines that the end of file has not been reached in step 245, the configuration management system may proceed to step 220 where it may read the next line of the configuration structure file.

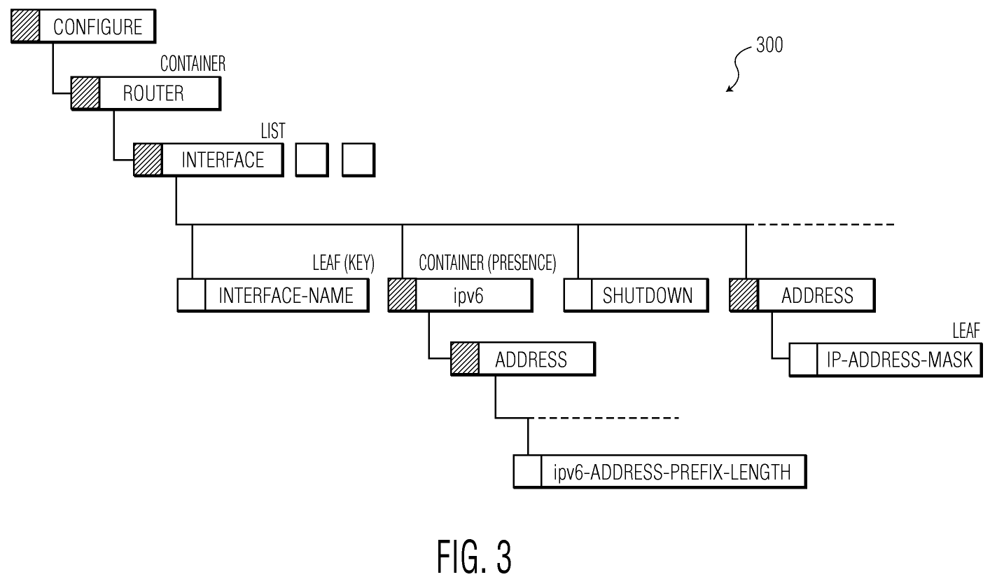

FIG. 3 illustrates an exemplary interface object model 300. The configuration management system may build the interface object model illustrated in FIG. 3. To build an object model one may use a Configuration file in any text format, parse the configuration commands of the node to identify the container and attribute through pattern matching. This interface object model, which can be represented in Yang, SMI or any other models is part of the generated model in step 250

As an example, suppose the goal is to build the object model of an interface. The following shows the portion of the configuration file related to an interface. It shows the configuration of an interface called “toNextRouter”: (An example of configuration file)

```
configure
  router
    interface “toNextRouter”
      address 35.250.13.32/23
      ipv6
          address 22::33/48
          no shutdown
      no shutdown
  exit
```

As shown in FIG. 3, in Object Model, one may consider the router to be a container object containing a list of interfaces. The interface itself may also be another container of multiple attributes. Interface container may be made up of attributes like interface-name (toNextRouter), address (35.250.13.23/23) and Operational State Shutdown.

One may identify a pattern found in a configuration file and parse it with pattern matchers and generate the data model file. Embodiments may use the configuration tree output to build a object model which is a relationship between different containers. In one example, the configuration tree output for an interface is shown in FIG. 3. Embodiments include using the pattern found in a space separator between the container objects and attribute values that end, for example, with “< . . . >” Pattern.

configure router interface <interface-name>
configure router interface address <ip-address/mask>
configure router interface port <port-id>

In one example, in step 210, one may parse a network element command structure file in any text format and parse it from the top. Step 215 may be to split a line with delimiters and identify if it is a container object. When a container object is present, in step 235 one may create a container class in object model file otherwise in step 230, configuration management system may check if it is attribute and one may add it as an attribute to a container in the object model in step 230. The process may be repeated until the end of file is reached.

An example object mode file includes:

```
<container name=”interface”>
    <attribute name=”interface-name”/>
    <attribute name=”address”/>
    <attribute name=”port”/>
  </container>
```

FIG. 4 illustrates an exemplary method for creation of a dependency model 400. Full Configuration Management of Multi-Vendor Multi-Domain Network Equipments may make use of the dependency model during deployment to order the deployment requests to the node. The dependency model may contain the sequence of <Object, Action> pairs.

In step 405, the configuration management system may create the object model in any format such as Simple Network Management Protocol Structure of Management Information (SNMP SMI), YANG model or any custom model.

The configuration management system may then proceed to step 410 where it may parse the object model from the top. The configuration management system may then proceed to step 415 where it may check if the selected object contains an attribute referring to an already parsed element container.

The configuration management system may then proceed to step 420 where it may determine if an already parsed element container found. When the reference is found, the configuration management system may proceed to step 430 where it may find the action associated with the element container in the action dependency file. In step 425, an action dependency file may be performed as an input to step 430. When action is found, the configuration management system may proceed to step 450 where it may read the next object.

The configuration management system may then proceed to step 435 from step 430 where it may determine whether the action was found.

The configuration management system may then proceed to step 440 when no action was found where it may prompt a user to input the action and then proceed to step 445. The configuration management system may then proceed to step 445 directly, when an action is found. In step 445 the configuration management system may add an object and action to the dependency file.

The configuration management system may then proceed to step 450 where it may read the next object.

The configuration management system may then proceed to step 455 where it may determine if the end of the object model file has been reached. When the end of file has not been reached, the configuration management system may proceed to step 415. The configuration management system may proceed to step 460 where it may stop the process, when the end of file has been reached.

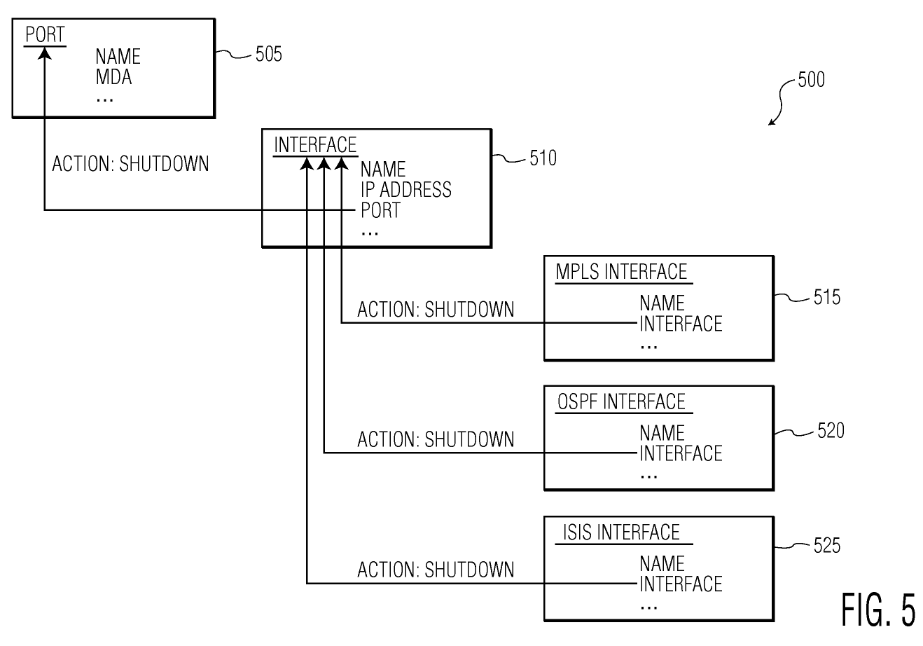

FIG. 5 illustrates an exemplary embodiment of a dependency model 500. Dependency model 500 may include port 505, interface 510, and MPLS, OSPF and ISIS interfaces 515-525. FIG. 5 shows the dependency hierarchy found in deployment model. In this example, Interface is dependent on Port and in turn OSPF, MPLS, ISIS interfaces are dependent on Interface. The dependency model will identify such dependencies by parsing and augmenting it with corresponding actions from action dependency file. Actions such as shutdown, delete and create are added to the dependency model to identify impact on depend object. In exemplifying the dependency model, one may use a Port, Interface and MPLS Protocol. One may additionally add two more protocols, such as Intermediate System to Intermediate System (ISIS) and/or Open Shortest Path First (OSPF).

The content of the dependency model for a MPLS, ISIS and OSPF interface is shown below. Note that this Model is order dependent (therefore the name is Dependency):

MPLS depends on Interface. <object,action> is <Interface, Shutdown)
OSPF depends on Interface. <object,action> is <Interface, Shutdown)
ISIS depends on Interface. <object,action> is <Interface, Shutdown)
Interface depends on Port. <object,action> is <Port, Shutdown)

Using the above dependency, if one wants to change the Metric attribute of MPLS interface, one may have to go interface first and find the port. So the order for pre-deployment of actions and objects may be:

<Port, Shutdown>
<Interface, Shutdown>

Having created the pre-deployment and post-deployment objects and actions, one is ready to use them during deployment. If one wants to change an attribute of MPLS interface for example, one may follow this order.

Deploy the pre- deployment <objects, actions> in order.
Deploy the Metric MPLS interface attribute change.
Deploy the post- deployment <objects, actions> in order.

In this example, the final order to change the Metric on an MPLS interface is:

1. Deploy <Port, Disable>
2. Deploy <Interface, Disable>
3. Deploy the Metric MPLS interface attribute change
4. Deploy <Port, Enable>
5. Deploy <Interface, Enable>

As another example, if the MTU is to be changed on an OSPF Interface, the order of deployment will be:

1. Deploy <Port, Disable>
2. Deploy <Interface, Disable>
3. Deploy the MTU OSPF interface attribute change
4. Deploy <Port, Enable>
5. Deploy <Interface, Enable>

In step 405 one may make use of Object Model of the Network Equipment. The Object Model may be parsed from the top. One may check if the parsed object is an Element Container or not. As an example, the MPLS Interface is an Element Container because it points to another object but the MPLS Metric is just an attribute and does not point to any other object (steps 410-415). If a reference to an Element Container is found (step 420), one may find the Action associated with this (step 425-430). The “Action Dependency File” may be optional in the logic. If present, its content may give the appropriate Action for an Object. If not present (step 435-440), the user may add the Action during the process of creation of the dependency model. The <Object, Action> pair will be added to dependency model File (step 445). As an example, if one may parse the MPLS Interface in Object Model, one may have to add <Interface, Shutdown) to the dependency model file. One may repeat this process (step 450-455) until one may reach the end of Object Model File. At this point the dependency model file may be ready to use with other component of FIG. 1 (step 460).

FIG. 6 illustrates an exemplary method for deployment logic 600.

The Full Configuration Management of Multi-Vendor Multi-Domain Network Equipments may make use of the dependency model during deployment to order the deployment requests to the node. The partial deployment to the network equipment may contain pre- and post-deployment of actions and objects.

For example, suppose the configuration management system has Ports, Interfaces and the MPLS Protocol, where the MPLS protocol is using the Interface. The configuration management system depends on Interface, and Interface in turn depends on Port. If one wants to change the metric attribute of the interface on the MPLS protocol, first one may have to find the interface and port used and disable both. This is called pre-deployment actions and objects. The objects are interface and port and actions are “Disable”.

This may be done by deploying the sequence of actions to the node in sequence for certain objects. In this case, one may have to disable Port first and then disable Interface. Then the Metric of the MPLS interface may be deployed to the network equipment. A the end, the port and interface should be enabled in sequence. These sequences of actions are called post-deployment actions and objects which are order dependent. As an example, the Port may be enabled first and then interface must be enabled.

In step 605, the partial deployment file may be parsed to find out the attributes, which should be modified. For example, a Metric of the MPLS interface. These may be called attribute #1, #2, . . . in step 605. Using the dependency model, the pre-deployment and post-deployment may be created for each attribute (Steps 655, 610, 640). Then for each attribute, one may go through all pre-deployment attribute #1, #2, . . . and deploy them to with appropriate actions to the network using any mediation the configuration management system supports. For example, Command Line Interface (CLI), NETCONF and TL1 may be used in steps 620, 625, 670, 675, and 680. When the deployment of the pre-deployment actions and objects are done in step 625, the deployment of the attribute #m may be done (Steps 630 and 635). Finally the post-deployment actions for attributes #1, #2 . . . may be deployed exactly similar to whatever one did for pre-deployment but in reverse order (Steps 655, 640, 645, and 650). One may repeat this process for each “attribute” until all are done (steps 665, 660). During the deployment of any attribute, in step 670 using the object model, one may find how to deploy attribute #m. Then in step 675 using the mediation layer, one may deploy the specific action for the specific attribute. Finally in step 680 one may perform mediation to the network using CLI, TL1, or NETCONF, for example. The Dependency Model contains the information related to the pre-deployment and post-deployment actions and objects and will be used during the deployment. The configuration management system can be run on various computers or network elements.

In one example, the configuration management system may begin in step 605 and parse the partial deployment file to find which attributes need to be modified. The configuration management system may proceed to step 610 where it may determine the pre-deployment sequence of objects and actions. The configuration management system may utilize the dependency mod el as input from step 615. The configuration management system may then proceed to steps 620-622 where it may perform steps 670-680 for each pre-deployment. In step 670, the configuration management system may determine how to deploy attribute #m using the object model and proceed to step 675. In step 675 the configuration management system may deploy the attribute #m which contains an object and action, using the mediation layer and proceed to step 680. In step 680 The configuration management system may perform mediation on the network.

In one example, the intention may be to modify the Metric on an MPLS Interface. If the data model is in Yang and the NETCONF is the mediation protocol, in step 670, using the data Model, the configuration management system may determine die properties of the Metric and MPLS Interface in the data model. Since the mediation protocol is NETCONF, in step 675, the configuration management system may open the NETCONF channel with the network element and construct the appropriate NETCONF Protocol Data Unit (PDU) to be sent to the network element. In step 680 the configuration management system may perform mediation on the network which may mean that it sends the NETCONF PDU to the network using the physical connectivity between network element and management system.

From step 680 the configuration management system may proceed to step 625 where the system may verify whether all pre-deployment is finished. The configuration management system may proceed to step 630 when all pre-deployment is finished. In step 630-632 the configuration management system may perform steps 670-680. In step 635 the configuration management system may verify that the configuration is completed for attribute #m and proceed to step 640. In step 640 the configuration management system may find the post-deployment sequence of objects and actions for each attribute and post-deployments. In steps 645-648 the configuration management system may perform steps 670-680 for each post-deployment. The configuration management system may proceed to step 650 when the system has completed and determine whether it is done with all post-deployment. From step 650, the configuration management system may proceed to step 660 where it may determine whether it is done with all attributes. When the configuration management system is done with all attributes it may proceed to step 665 where it may stop. When the configuration management system is not done with all attributes it may return to step 610 where it may continue operation.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method of configuration of a multi-domain multi-vendor network device, the method comprising:
building an Object Model;
creating an XML Equivalent using a network configuration file as input;
creating a dependency model; and
performing both full and partial deployment logic using the dependency model.

2. The method of claim 1, wherein the deployment logic further comprises:
parsing a partial deployment file to identify a sequence of objects and actions; and
finding a pre-deployment and post-deployment sequence of objects and actions.

3. The method of claim 2, wherein the deployment logic further comprises:
for each pre-deployment and post-deployment:
using the object model to find how to deploy an attribute; and
deploying the attribute which contains an object and action.

4. The method of claim 3, wherein the deployment logic further comprises:
for each attribute:
using the object model to find how to deploy an attribute; and
deploying the attribute which contains an object and action.

5. The method of claim 4, wherein creating the Dependency Model further comprises:
parsing the object model; and
checking if the selected object contains attribute(s) referring to an already parsed element container.

6. The method of claim 5, wherein creating the Dependency Model further comprises:
when a reference is found, finding the action associated with the object in an action dependency file.

7. The method of claim 6, wherein creating the Dependency Model further comprises:
when the action is found, adding the object and action to the action dependency file.

8. The method of claim 1, wherein building the Object Model further comprises:
receiving a network element configuration command structure file in any text format; and
parsing the network element configuration command structure file.

9. The method of claim 8, wherein building the object model further comprises:
using a character type delimiter, finding if there is an object container; and
when an object container is found, adding the container and the structure to an object model file.

10. A network device configured to perform a method of configuration, the device comprising:
a memory; and
a processor configured to:
building an Object Model;
creating the XML-Equivalent using the network configuration file as input;
creating a dependency model; and
performing both full and partial deployment logic using the dependency model.

11. The device of claim 10, wherein to perform the deployment logic the processor is further configured to:
parse a partial deployment file to identify a sequence of objects and actions; and
find a pre-deployment and post-deployment sequence of objects and actions.

12. The device of claim 11, wherein to perform the deployment logic the processor is further configured to:
for each pre-deployment and post-deployment:
use the object model to find how to deploy an attribute; and
deploy the attribute which contains an object and action.

13. The device of claim 12, wherein to perform the deployment logic the processor is further configured to:
for each attribute:
use the object model to find how to deploy an attribute; and
deploy the attribute which contains an object and action.

14. The device of claim 13, wherein to create the dependency model the processor is further configured to:
parse the Object Model; and
check if the selected object contains attribute(s) referring to an already parsed element container.

15. The device of claim 14, wherein to create the dependency model the processor is further configured to:
when a reference is found, find the action associated with the object in an action dependency file.

16. The device of claim 15, wherein to create the dependency model the processor is further configured to:
when the action is found, add the object and action to die action dependency file.

17. The device of claim 10, wherein to build the Object Model the processor is further configured to:
receive a network element configuration command structure file in any text format; and
parse the network element configuration command structure file.

18. The device of claim 17, wherein to build the object model the processor is further configured to:
use a character type delimiter, finding if there is an object container; and
when an object container is found, add the container and the structure to an object model file.

19. A non-transitory machine-readable storage medium encoded with instructions for configuration of a multi-domain multi-vendor network device, die medium comprising:
instructions for building an Object Model;
instructions for creating an XML-Equivalent using a network configuration file as input;
instructions for creating a dependency model; and
instructions for performing both full and partial deployment logic using the dependency model.

20. The storage medium of claim 19, wherein the deployment logic further comprises:
instructions for parsing a partial deployment file to identify a sequence of objects and actions; and
instructions for finding a pre-deployment and post-deployment sequence of objects and actions.
